(19) United States
(12) Patent Application Publication
(10) Pub. No.: US 2026/0017909 A1
(43) Pub. Date: Jan. 15, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: Yusuke BABA, Tokyo (JP); Masafumi TAKIMOTO, Kanagawa (JP)

(21) Appl. No.: 19/263,608

(22) Filed: Jul. 9, 2025

(30) Foreign Application Priority Data
Jul. 11, 2024 (JP) 2024-111842

(51) Int. Cl. G06T 19/20

(52) U.S. Cl. CPC G06T 19/20; G06T 2210/36; G06T 2219/2021

(57) ABSTRACT

A technique disclosed herein creates a 3D shape model with a higher level of detail based on multiple different 3D shape models. Multiple 3D shape models for the same object are obtained and the likelihood (first likelihood) of each of polygons constituting each of the obtained 3D shape models is calculated. Using estimated skeleton data, the multiple 3D shape models with different poses are transformed into the same pose. Then, scale conversion is performed on the pose-transformed 3D shape models containing the pose-transformed skeleton data. The likelihood (second likelihood) of polygons in each certain subregion is calculated from the calculated likelihoods (first likelihoods) of the polygons. Subregions with the highest likelihoods (second likelihoods) of the polygons are extracted from the multiple 3D shape models, and combined to create a single 3D shape model.

### BACKGROUND

### Field

The present disclosure relates to an information processing technique for processing three-dimensional shape information.

### Description of the Related Art

In recent years, many three-dimensional (3D) shape reconstruction techniques using deep learning have been proposed as techniques for creating a 3D shape model from a two-dimensional (2D) image. With these methods, a region that cannot be observed from a 2D image can be reconstructed using an estimation result by a trained model.

For example, a trained model that estimates a 3D shape model using a 2D image of a person captured from one side and the corresponding ground truth 3D shape model as training data can estimate a statistically plausible 3D shape model from a 2D image in which one side of a person is captured. Shunsuke Saito, Zeng Huang, Ryota Natsume, Shigeo Morishima, Angjoo Kanazawa, and Hao Li. PIFu: Pixel-aligned implicit function for high-resolution clothed human digitization. In Proc. of the IEEE International Conf. on Computer Vision (ICCV), 2019 (abbreviated as Non Patent Literature 1, below) discloses a method of estimating a 3D shape model from a single input image based on statistical information obtained by pre-training. For example, from a single frontal image of a person, a plausible 3D shape model including the back side not contained in the input information can be estimated. However, in terms of a level of detail, an unobserved side estimated only from the statistical information obtained by pre-training is inferior to an observed side that can be estimated by using the observational information.

Chung-Yi Weng, Brian Curless, Pratul P. Srinivasan, Jonathan T. Barron, and Ira Kemelmacher-Shlizerman. “HumanNeRF: Free-viewpoint rendering of moving people from monocular video”, In Proceedings of the IEEE/CVF Conference on Computer Vision and Pattern Recognition (CVPR), 2022 (abbreviated as Non Patent Literature 2, below) discloses a method of obtaining a 3D shape model with a canonical pose from a video sequence by optimization. In Non Patent Literature 2, the pose of an object to be reconstructed in an observation space is normalized, the radiance fields of a person in the normalized space are optimized throughout the entire sequence, and a single 3D shape model for the person is obtained from the information of the entire sequence.

### SUMMARY

However, in the technique in Non Patent Literature 2, a single 3D shape model is estimated from the averaged observational information of the entire sequence as an input, which may result in a loss of details of the observational information in each of individual frames observed instantaneously.

The technique disclosed herein has an object to create a 3D shape model with a higher level of detail based on multiple different 3D shape models.

The technique disclosed herein is characterized by comprising: one or more hardware processors; and one or more memories storing one or more programs configured to be executed by the one or more hardware processors, the one or more programs including instructions for: obtaining a plurality of different three-dimensional shape models for a single object; calculating a likelihood of each of subregions in each of the plurality of three-dimensional shape models; and creating a single three-dimensional shape model for the single object by combining subregions in the plurality of three-dimensional shape models based on the likelihoods.

Features of the present disclosure will become apparent from the following description of embodiments with reference to the attached drawings. The following description of embodiments is described by way of example.

### BRIEF DESCRIPTION OF THE DRAWINGS

FIG. 1A is a diagram illustrating a hardware configuration example of an information processing apparatus according to Embodiment 1;

FIG. 1B is a diagram illustrating a hardware configuration example of an information processing apparatus according to Embodiment 1;

FIG. 1C is a diagram illustrating a hardware configuration example of an information processing apparatus according to Embodiment 1;

FIG. 2 is a diagram illustrating an example of input and output images of a 3D reconstruction DNN;

FIG. 3A is a flowchart for explaining 3D shape model creation processing according to Embodiment 1;

FIG. 3B is a flowchart for explaining the 3D shape model creation processing according to Embodiment 1;

FIG. 3C is a flowchart for explaining the 3D shape model creation processing according to Embodiment 1;

FIG. 3D is a flowchart for explaining the 3D shape model creation processing according to Embodiment 1;

FIG. 3E is a flowchart for explaining the 3D shape model creation processing according to Embodiment 1;

FIG. 4A is a diagram illustrating an example of skeleton representation;

FIG. 4B is a diagram illustrating an example of skeleton representation;

FIG. 4C is a diagram illustrating an example of skeleton representation;

FIG. 5A is a diagram illustrating an example of inputs and outputs of 3D reconstruction DNNs according to Embodiment 1;

FIG. 5B is a diagram illustrating an example of an input and outputs of a 3D reconstruction DNN according to Embodiment 1;

FIG. 5C is a diagram illustrating an example of an input and outputs of 3D reconstruction DNNs according to Embodiment 1;

FIG. 6 is a diagram illustrating a positional relationship between an object and virtual cameras placed in a virtual 3D space;

FIG. 7 is a diagram illustrating a positional relationship between an object and image capture cameras;

FIG. 8A is a diagram for explaining a method of estimating a surface position of a 3D shape model;

FIG. 8B is a diagram for explaining the method of estimating a surface position of a 3D shape model;

FIG. 8C is a diagram for explaining the method of estimating a surface position of a 3D shape model;

FIG. 9A is a diagram schematically illustrating a step of creating 3D shape models with the same pose from two-dimensional images according to Embodiment 1;

FIG. 9B is a diagram schematically illustrating the step of creating 3D shape models with the same pose from two-dimensional images according to Embodiment 1;

FIG. 10 is a diagram schematically illustrating a scale conversion process according to Embodiment 1;

FIG. 11 is a conceptual diagram presenting a method of creating a 3D shape model based on multiple 3D shape models according to Embodiment 1;

FIG. 12 is a diagram illustrating an example where a 3D space in which a 3D shape model is present is divided by grids;

FIG. 13A is a diagram for explaining a method of combining scale-adjusted 3D shape models according to Embodiment 1;

FIG. 13B is a diagram for explaining the method of combining scale-adjusted 3D shape models according to Embodiment 1;

FIG. 14A is a flowchart for explaining 3D shape model creation processing according to Embodiment 2;

FIG. 14B is a flowchart for explaining the 3D shape model creation processing according to Embodiment 2;

FIG. 15A is a diagram illustrating an example of a UI screen according to Embodiment 2;

FIG. 15B is a diagram illustrating an example of a UI screen according to Embodiment 2;

FIG. 15C is a diagram illustrating an example of a UI screen according to Embodiment 2;

FIG. 15D is a diagram illustrating an example of a UI screen according to Embodiment 2;

FIG. 15E is a diagram illustrating an example of a UI screen according to Embodiment 2; and

FIG. 15F is a diagram illustrating an example of a UI screen according to Embodiment 2.

### DESCRIPTION OF THE EMBODIMENTS

Hereinafter, embodiments according to the present disclosure will be described with reference to the drawings. The following embodiments are not intended to limit the technique of the present disclosure. In addition, all the combinations of features described in the embodiments are not necessarily essential for the solution of the present disclosure. The configurations in the embodiments may be modified or altered as appropriate depending on specifications of an apparatus and various conditions (such as usage conditions or a usage environment) to which the technique of the present disclosure is applied. In the following embodiments, the same or similar constituents will be assigned with the same reference sign, and repetitive description thereof will be omitted.

### Embodiment 1

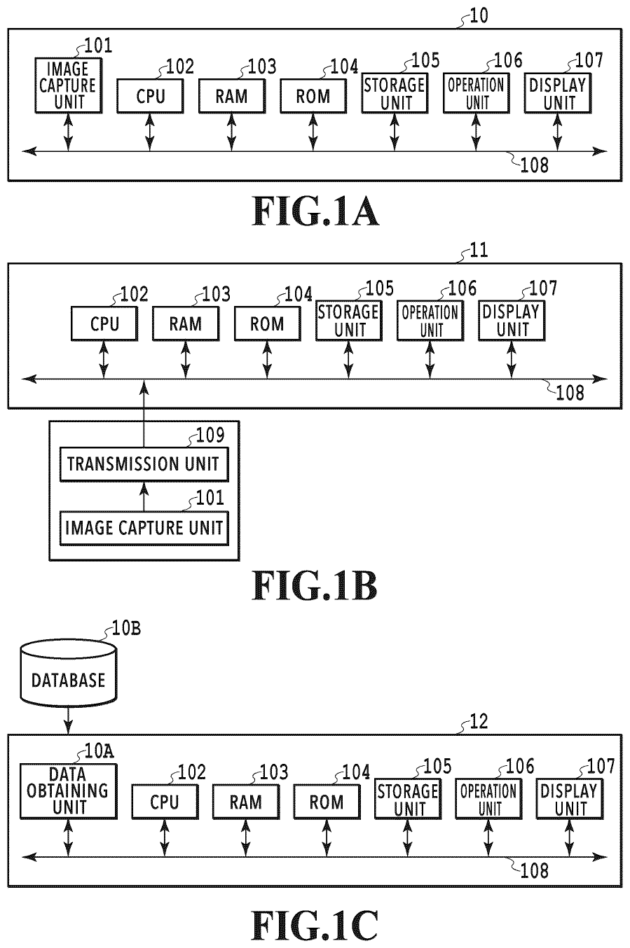

FIGS. 1A to 1C present hardware configurations of information processing apparatuses in the present embodiment. An information processing apparatus 10 presented in FIG. 1A is assumed to be a PC, a smartphone, or a tablet terminal, and includes an image capture unit 101, a CPU 102, a RAM 103, a ROM 104, a storage unit 105, an operation unit 106, and a display unit 107.

The image capture unit 101 includes an image capturing element and an image generation processing unit, and outputs an captured image to the storage unit 105.

The CPU 102 executes various processes by using computer programs and data stored in the RAM 103 and the ROM 104. Thus, the CPU 102 executes or controls various processes to be described as controlling operations of the entire information processing apparatus 10.

The RAM 103 has an area for storing the computer programs and data loaded from the ROM 104 and the storage unit 105 and an area for storing data received from many capture groups. In addition, the RAM 103 has a work area to be used by CPU 102 to execute the various processes. In this way, the RAM 103 can provide various areas as needed.

The ROM 104 stores setting data of the information processing apparatus 10, a computer program and data related to startup, a computer program and data related to basic operations, and so on.

The storage unit 105 is a hard disk drive device or the like. The storage unit 105 stores an operating system (OS) and a computer program and data for causing the CPU 102 to execute or control various processes to be described as being executed by the information processing apparatus 10. The data stored in the storage unit 105 contains captured images generated by the image capture unit 101 and data related to deep neural network (DNN) models that execute 3D reconstitutions. The computer programs and the data stored in the storage unit 105 are loaded to the RAM 103 as needed under control of the CPU 102, and processed by the CPU 102.

The operation unit 106 is a user interface such as a keyboard, a mouse, or a touch panel. By operating the operation unit 106, a user is enabled to input various instructions to the CPU 102.

The display unit 107 has a screen such as a liquid crystal screen or a touch panel screen, and is capable of displaying images, texts, and so on presenting processing results by the CPU 102. The display unit 107 may be a projection device such as a projector that projects images and texts.

All of the image capture unit 101, the CPU 102, the RAM 103, the ROM 104, the storage unit 105, the operation unit 106, and the display unit 107 are connected to a system bus 108.

Here, as illustrated in FIG. 1B, an image capture unit 101 may be independent of an information processing apparatus 11. In this case, a transmission unit 109 transmits captured-image information containing captured images to the information processing apparatus 11. Also, the configuration may include only the information processing apparatus 11 or include a data obtaining unit 10A and a database 10B which is independent of an information processing apparatus 12 and which stores captured-image information as illustrated in FIG. 1C. The configurations of the information processing apparatuses are not limited to those in FIGS. 1A to 1C. The operation unit 106 and the display unit 107 may be included in an information processing apparatus other than the information processing apparatus 10.

The aforementioned information processing apparatus 10, 11, or 12 obtains 3D shape models, calculates first likelihoods, calculates second likelihoods, and creates a 3D shape model according to the present disclosure. Hereinafter, processes in the constituents of the present disclosure will be described.

By using a DNN model, it is possible to estimate a 3D shape model from a single input image. However, among 3D shape models thus estimated, regions with high estimation accuracy are different due to differences in the observational information contained in input images. In the present embodiment, subregions with high estimation accuracy are extracted from multiple 3D shape models for the same object estimated from multiple input images containing different observational information, and an accurate 3D shape model is created by combining these subregions.

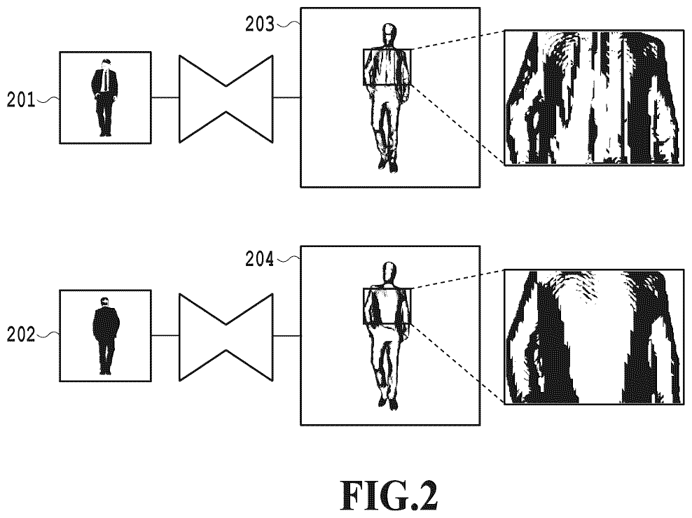

FIG. 2 presents an example of input and output images of a 3D reconstitution DNN. In a 3D shape model 203 estimated from an input 2D image 201 which is captured from the front side of an object and which contains unevenness information of a jacket, a shirt, and a tie, the unevenness of the jacket, the shirt, and the tie is reproduced. In contrast, in a 3D shape model 204 estimated from an input 2D image 202 captured from the back side of the object, a region around the breasts where the unevenness of the jacket and the tie should be present is estimated as a flat region. Since a 3D shape model is estimated by using the DNN model only based on the observational information contained in an input image and parameter information obtained by pre-training, a region with little observational information tends to have the reproducibility and estimation accuracy lower than in a region with abundant observational information.

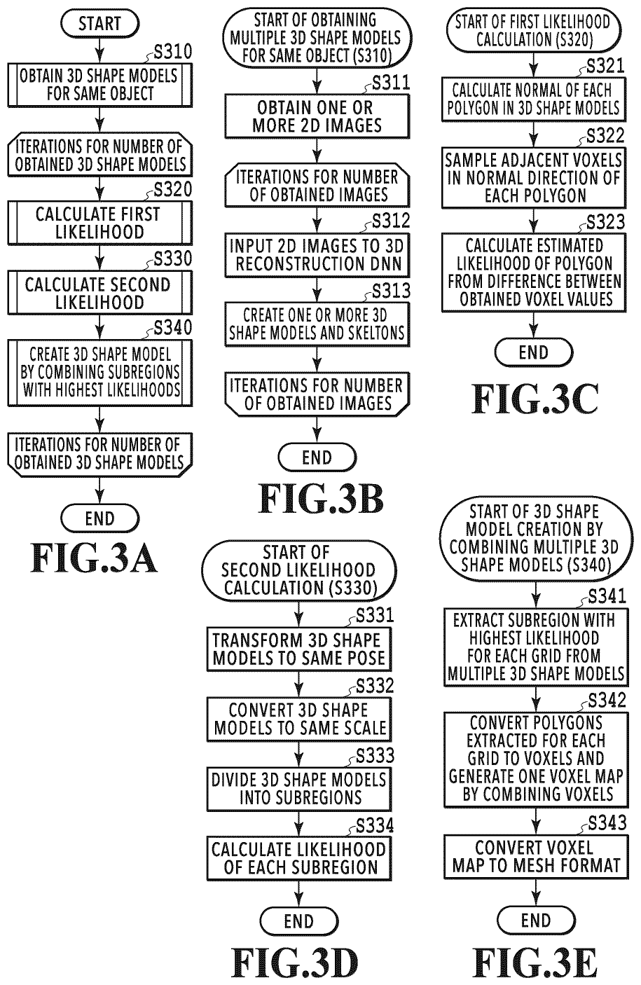

FIGS. 3A to 3 present flowcharts for explaining 3D shape model creation processing according to the present embodiment. In the technique of the present disclosure, a type of object targeted for a 3D shape model creation is not particularly limited. In the present embodiment, however, a case of creating a 3D shape model for a person will be described as an example.

FIG. 3A presents a flowchart for explaining the 3D shape model creation processing according to the present embodiment.

In S310, the CPU 102 obtains multiple 3D shape models for the same object. The same object mentioned herein may include objects in the same category, such as “persons” and is not limited to the exactly same object (for example, the same person in the category “person”).

In S320, the CPU 102 calculates a likelihood (first likelihood) of each of polygons constituting each of the 3D shape models obtained using 3D reconstruction DNNs in S310. The first likelihood mentioned herein is an estimation confidence score of each of the polygons constituting the 3D shape model estimated by the 3D reconstruction DNN.

In S330, the CPU 102 calculates a likelihood (second likelihood) of a polygon in a certain region from the likelihoods (first likelihoods) of the polygons calculated in S320.

In S340, the CPU 102 creates a 3D shape model by combining subregions with the highest likelihoods (second likelihoods) of the polygons calculated in S330.

### <Process of Obtaining Multiple 3D Shape Models For Same Object (S310)>

Hereinafter, the process of obtaining multiple 3D shape models for the same object in S310 will be described. FIG. 3B presents a flowchart for explaining the process of obtaining 3D shape models for the same object in S310.

In S311, the CPU 102 obtains a 2D moving image or multiple still images in which a person targeted for a 3D shape model creation is captured.

Next, the following steps S312 and S313 are iterated the same number of times as the number of the images obtained.

In S312, the CPU 102 inputs multiple frames of the 2D moving image or the multiple still images obtained in S311 to the 3D reconstruction DNNs.

In S313, the CPU 102 obtains data of 3D shape models and skeletons (skeleton models) output from the 3D reconstruction DNNs, and stores the data to the storage unit 105.

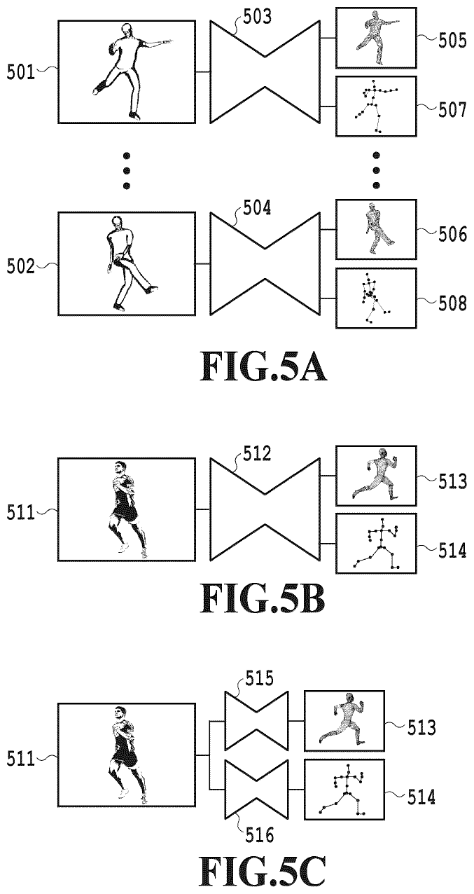

FIG. 5A illustrates an example of inputs and outputs of the 3D reconstruction DNNs used in the present embodiment. In the present embodiment, as illustrated in FIG. 5A, from multiple input images 501, . . . , 502 in which the same person is captured, the 3D reconstruction DNNs 503, . . . , 504 estimate 3D shape models 505, . . . , 506 and skeletons 507, . . . , 508. FIG. 5B is used for explanation. An input image 511 is input to a 3D reconstruction DNN 512, and the 3D reconstruction DNN 512 outputs a 3D shape model 513 and a skeleton 514. In FIGS. 5A and 5B, the 3D reconstruction DNN architecture is illustrated in the form of Hourglass Network, but the DNN architecture is not limited to this. In addition, different DNNs may be used as a 3D shape model estimation DNN 515 and a skeleton estimation DNN 516 as illustrated in FIG. 5C.

Here, a 3D reconstruction DNN training method will be described. The 3D reconstruction DNN in the present embodiment estimates a 3D voxel map of a 3D shape model and skeleton data indicating joint positions. First, a training method for estimation of a 3D voxel map of a 3D shape model will be described. Training data used is a pair of a 3D CG object to serve as ground truth (hereinafter referred to as a ground truth object) and a 2D virtual viewpoint image in which the ground truth object is rendered by a virtual camera.

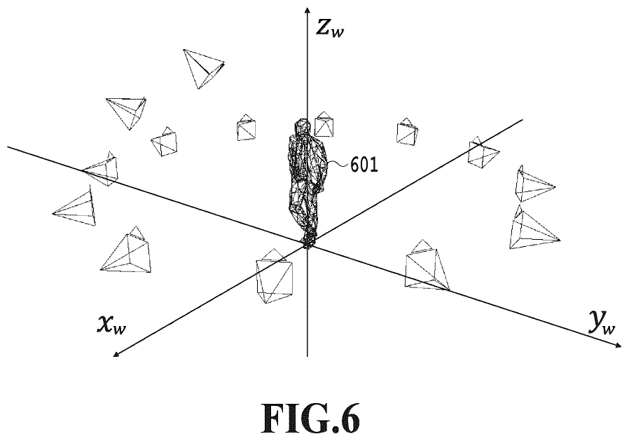

FIG. 6 presents a ground truth object 601 and virtual cameras placed in a virtual 3D space. Input images are 2D virtual viewpoint images obtained by rendering the ground truth object 601 from the viewpoints of the respective virtual cameras. A loss to be used to optimize the 3D reconstruction DNN is defined as the difference between the ground truth object 601 and a 3D shape model estimated by the 3D reconstruction DNN 512. The data format of the 3D shape models used in the training is a 3D occupancy field, where the inside of a target object region is expressed by 1 and the outside of the target object region is expressed by 0. Therefore, the ground truth object 601 holds two values as correct values, and a voxel value fᵥ*(X) of the ground truth object at voxel position coordinates X is expressed as Formula (1).

$${f}_{v}^{*} ( X ) = \{ \begin{matrix}1 , & if X is inside the object surface \\ 0 , & otherwise\end{matrix} \qquad Formula ( 1 )$$

In contrast, the 3D reconstruction DNN outputs, as an estimated voxel value f_{V}(X), a continuous value in a range of 0 to 1 for each voxel position coordinate point X in the 3D occupancy field. Hereafter, a 3D occupancy field onto which the estimated voxel values f_{V}(X) output by the 3D reconstruction DNN are mapped is referred to as a 3D voxel map. The estimated voxel value fᵥ(X) of the 3D reconstruction DNN at the voxel position coordinates X is determined by an image feature g(I(x)) obtained by an image encoder g from pixel position coordinates x in an input image I. The voxel position coordinates X and the pixel position coordinates x are expressed as x=π(X) (π: 2D projection function). In the case where F_{V}(x)=g(I(x)) and fᵥ denotes a function to calculate the voxel value at the voxel position coordinates X from the image feature, the estimated voxel value can be expressed as fᵥ(F_{V}(x), z(X)). Here, z(X) denotes a depth value at the voxel position coordinates X viewed from the image capture camera coordinates. In the case where the number of voxels sampled is denoted by n_{V}, the loss L_{V} is expressed as Formula (2).

$${L}_{V} = \frac{1}{{n}_{V}} {\sum }_{i = 1}^{{n}_{V}} \vert {f}_{v} ( {F}_{V} ( {x}_{i} ) , z ( {X}_{i} ) ) - {f}_{v}^{*} ( {X}_{i} ) \vert \qquad Formula ( 2 )$$

The training of the 3D reconstruction DNN for 3D shape model estimation is performed so as to minimize the loss L_{V} obtained in this way.

Here, a 3D shape model is obtained by converting the 3D voxel map with continuous values output by the 3D reconstruction DNN into binary values of 0 and 1 by threshold processing or by converting the 3D voxel map into a mesh format using the marching cubes method or the like.

Next, the training method for skeleton estimation will be described. The training data to be used for skeleton estimation is a pair of a ground truth 3D skeleton and an input image in which a CG object having this ground truth 3D skeleton is rendered. There are several skeleton data formats, which differ mainly in the number of joints. In the present disclosure, the skeleton data format is not particularly limited.

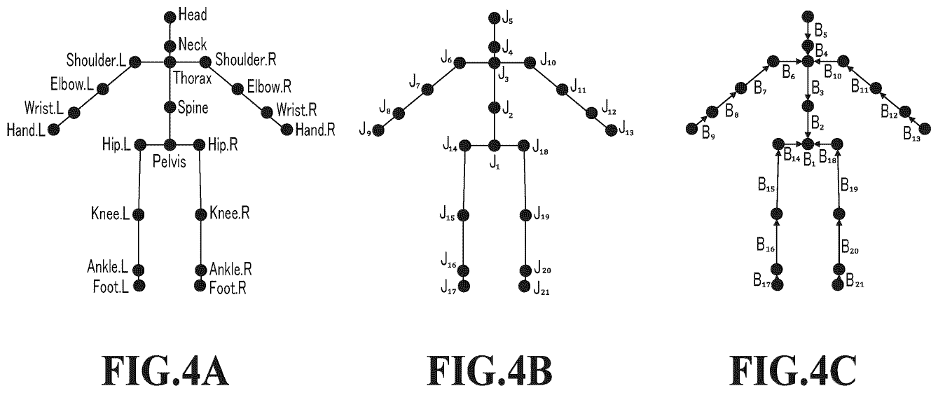

FIG. 4A presents an example of a skeleton representation. Position coordinates of each joint in the skeleton representation in FIG. 4A are denoted by Jₕ (h=1, . . . , H) as presented in FIG. 4B. In the skeleton representation in FIG. 4A, H is equal to 21.

The 3D reconstruction DNN 512 outputs H 3D confidence maps. The coordinate system of this 3D confidence map is the same as the coordinate system of the 3D voxel map to be used to estimate a 3D shape model. Each 3D confidence map is a map where a probability of the corresponding one joint being present is mapped to voxel position coordinates, and the voxel position coordinates having the highest probability of the joint being present are determined as the joint position coordinates. In the case where a probability of a joint being present at position coordinates X_{W} on a 3D confidence map is denoted by P(X_{W}), the estimated joint position coordinates Jn are expressed as Formula (3).

$${J}_{h} = arg m {a}_{{X}_{w}} \times P ( {X}_{w} ) \qquad Formula ( 3 )$$

The loss L_{Skel} to be used in the training for skeleton estimation may be defined as the distance between the estimated joint position and the ground truth joint position, but is herein defined as follows by taking advantage of the characteristics of skeleton data having a tree structure.

The connection relationships of each joint to the other joints are defined by a tree structure rooted at Pelvis in the skeleton representation presented in FIG. 4A. Of two joints directly connected together among these joints, the joint closer to the root joint 1 is defined as a parent joint, and the parent joint of a joint h (h>1) is defined as a parent(h). In the case where each branch connecting a joint h to its parent joint parent(h) is replaced with a 3D vector Bₕ as presented in FIG. 4C, the vector Bₕ is expressed as Formula (4). The 3D vector Bₕ will be referred to as a skeleton vector below.

$${B}_{h} = \{ \begin{matrix}{J}_{1} - O , & h = 1 \\ {J}_{parent ( h )} - {J}_{h} , & h = 2 , … , H\end{matrix} \qquad Formula ( 4 )$$

Here, a set of indices of joints existing on a path from a joint h to the root joint 1 is denoted by Uₕ={h, parent(h), parent(parent(h)), . . . , 1}. For example, in a case where h=9, U₉ is a set of seven indices, where U₉={9, 8, 7, 6, 3, 2, 1} based on the positional relationships among the joints presented in FIG. 4B. In the case where an estimated skeleton vector based on the joint position coordinates [symbol] (h=1, . . . , H) estimated by the 3D reconstruction DNN is denoted by \tilde{B} and the ground truth skeleton vector is denoted by B, the loss L_{Skel} with the characteristics of the skeleton data taken into consideration can be defined as Formula (5).

$${L}_{Skel} = {\sum }_{h = 1}^{H} {\sum }_{u ∈ {U}_{h}} \vert {\tilde{B}}_{u} - {B}_{u} \vert \qquad Formula ( 5 )$$

The training of the 3D reconstruction DNN for skeleton estimation is performed so as to minimize the loss L_{Skel} obtained in this way.

The 3D shape model and the skeleton data obtained in S310 may be obtained from the database 10B in which multiple 3D shape models for the object to be reconstructed and the corresponding skeleton data, which were estimated in the past, are stored in advance.

### <First Likelihood Calculation Process (S320)>

Hereinafter, the first likelihood calculation process in S320 will be described.

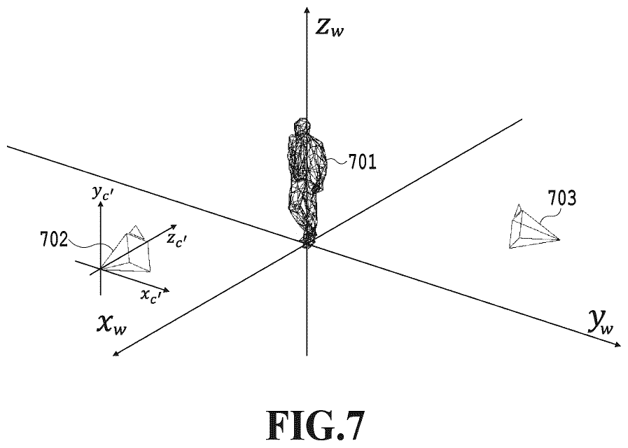

FIG. 3C presents a flowchart for explaining the first likelihood calculation process in S320. Here, considered is a case where a 3D shape model is estimated from a captured image of an object 701 in FIG. 7 obtained by an image capture camera 702 located on an x_{W} axis in a global coordinate system. In this case, from the information in the captured image, it is easy to accurately estimate the position of a surface of a 3D shape model having a normal consisting only of components in the x_{c′} and y_{c′} directions in a camera coordinate system of the image capture camera 702 (y_{W} and z_{W} directions in the global coordinate system). On the other hand, it is difficult to accurately estimate the position of a surface of the 3D shape model, where the surface's normal not only includes the x_{c′} and y_{c′} directions but also includes a component in the ze direction, which is the depth direction in the camera coordinate system of the image capture camera 702 (x_{W} direction in the global coordinate system). In contrast, in the case where a 3D shape model is estimated from an image captured by an image capture camera 703, directions in which the surface position can be estimated easily with high accuracy are the x_{W} and z_{W} directions in the global coordinate system, while the direction in which the surface position is difficult to estimate with high accuracy is the y_{W} direction in the global coordinate system. Thus, a region that can be easily estimated with high accuracy by the 3D reconstruction DNN varies depending on a positional relationship between an object and an image capture camera.

The 3D reconstruction DNN outputs, as the probability of each voxel being present inside the object region, a continuous value within the range of 0 to 1. The 3D reconstruction DNN outputs a value close to 1 in a case where an estimation target voxel can be estimated with high accuracy to be inside the object region, and outputs a value close to 0 in a case where the estimation target voxel can be estimated with high accuracy to be outside the object region. In addition, in a case where it is difficult to accurately estimate whether the estimation target voxel is inside or outside the object region, the 3D reconstruction DNN outputs a value close to the median value of 0.5.

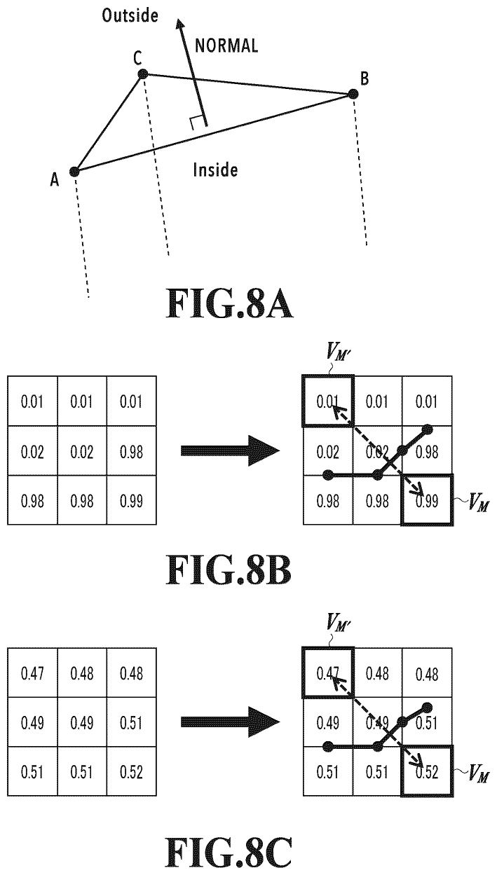

FIG. 8B presents a cross-sectional view of an example where the marching cubes method is applied to an estimated 3D voxel map, under the assumption that the surface position of the 3D shape model is estimated with high accuracy (i.e. high likelihood). Here, a threshold value in the marching cubes method is set to 0.5, and the surface is determined to exist in each region with a voxel value of 0.5 or greater. FIG. 8C presents a cross-sectional view of an example where the marching cubes method is applied to an estimated 3D voxel map assuming that the estimation of the surface position with high accuracy is difficult (i.e. low likelihood). The greater the difference in the estimated voxel value between adjacent voxels across a surface, the higher the likelihood, whereas the smaller the difference, the lower the likelihood.

In S321, the CPU 102 calculates a normal vector of each polygon. The normal vector of the polygon constituted by three points A, B, and C as presented in FIG. 8A may be calculated from the cross product of a vector AB and a vector AC.

In S322, the CPU 102 extracts adjacent voxels by using the normal direction calculated in S321.

In S323, the CPU 102 calculates the likelihood of the polygon based on the difference in the voxel value between a voxel abutting on the polygon and a voxel adjacent to that voxel. The difference in the estimated value between the two voxels becomes larger as the estimation of the surface position with high accuracy becomes easier as presented in FIG. 8B, whereas the difference in the estimated value between the two voxels becomes smaller as the estimation of the surface position with high accuracy becomes more difficult as presented in FIG. 8C. The likelihood of the polygon is calculated from the difference in the estimated value between the two voxels. In the case where adjacent voxels in the inside and outside directions of a polygon M are denoted by V_{M}, V_{M′} and their estimated values are denoted by F_{V}_{_{M}}, F_{V}_{_{M′}}, the likelihood LH_{M} of the polygon M is expressed as Formula (6).

$${LH}_{M} = \vert {{F}_{V}}_{M} - {F}_{{V}_{{M}^{′}}} \vert \qquad Formula ( 6 )$$

### <Second Likelihood Calculation Process (S330)>

Hereinafter, the second likelihood calculation process will be described. FIG. 3D presents a flowchart for explaining the second likelihood calculation process in S330.

In S331, using the estimated skeleton data, the CPU 102 transforms multiple 3D shape models with different poses into the 3D shape models with the same pose. Here, the transformation to a canonical T-pose will be described. In the case where the point coordinates of the 3D shape model before pose transformation are denoted by sₒ (∈Sₒ) and the point coordinates after the pose transformation are denoted by s_{T} (∈S_{T}), a process of transforming a canonical T-pose S_{T} to a pose Sₒ can be expressed as Formula (7).

$${s}_{o} = ( \begin{matrix}{\sum }_{h = 1}^{H} & {w}_{T}^{h} {D}_{h}\end{matrix} ) {s}_{T} , {\sum }_{h = 1}^{H} {w}_{T}^{h} = 1 \qquad Formula ( 7 )$$

In the above formula,

$${w}_{T}^{h}$$

denotes a degree of influence on the point s_{T} at a joint (h), and the sum of

$${w}_{T}^{h}$$

is 1. Dₕ is the rotation matrix of the joint h due to the pose transformation. A process of transforming the pose Sₒ before the transformation to the canonical T-pose S_{T} can be expressed as Formula (8).

$${s}_{T} = {( {\sum }_{h = 1}^{H} {w}_{T}^{h} {D}_{h} )}^{- 1} {s}_{o} \qquad Formula ( 8 )$$

In the above formula,

$${w}_{T}^{h}$$

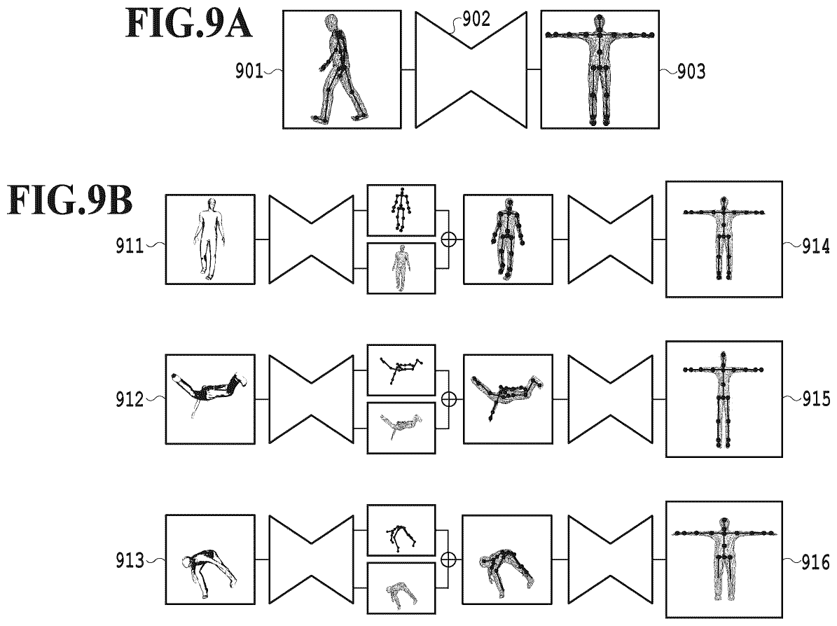

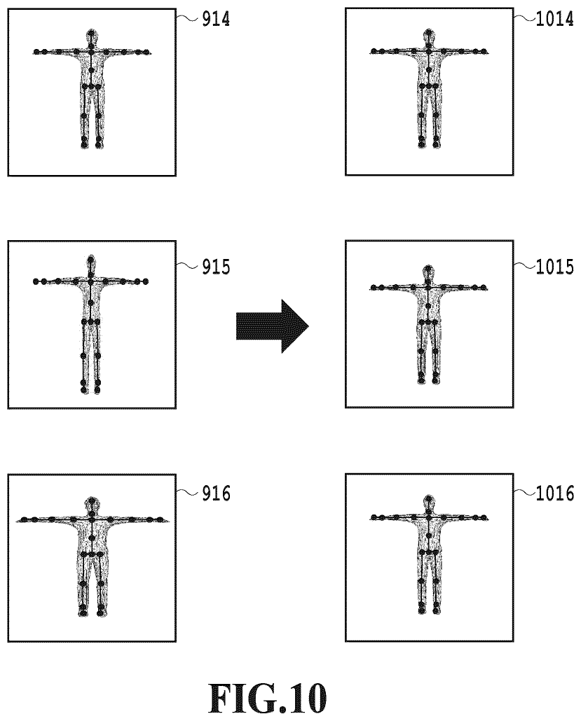

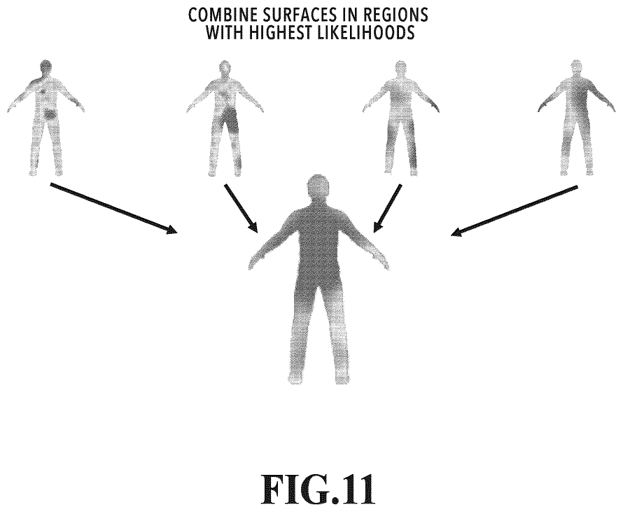

may be a parameter defined in advance in the skeleton data used, or be a value defined by optimization by a pose transformation DNN. FIG. 9A presents an example of an input and an output of the pose transformation DNN. A pose transformation DNN 902 receives a 3D shape model 901 before pose transformation containing the skeleton data, and outputs a pose-transformed 3D shape model 903 containing the skeleton data. The pose transformation DNN 902 is trained by using datasets each consisting of a pair of a ground truth pose 3D shape model and an input 3D shape model before pose transformation. The point coordinates on the ground truth pose 3D shape model S_{gt} are denoted by s_{gt} (∈S_{gt}) and the point coordinates of an estimated pose-transformed 3D shape model are denoted by s_{pred} (∈S_{pred}). Using the chamfer distance, a loss function CD can be expressed as Formula (9).

$$C D ( {S}_{p r e d} , {S}_{gt} ) = \frac{1}{\vert {S}_{p r e d} \vert} {\sum }_{{s}_{p r e d} ∈ {S}_{p r e d}} {min}_{{s}_{gt} ∈ {S}_{gt}} \vert {s}_{p r e d} - {s}_{gt} \vert + \frac{1}{\vert {S}_{gt} \vert} {\sum }_{{s}_{gt} ∈ {S}_{gt}} {min}_{{s}_{pred} ∈ {S}_{pred}} \vert {s}_{gt} - {s}_{p r e d} \vert \qquad Formula ( 9 )$$

FIG. 9B schematically presents a process flow for estimating multiple pose-transformed 3D shape models 914 to 916 with the same pose from multiple input images 911 to 913 with different poses using the pose transformation DNN. First, the multiple input images 911 to 913 with the different poses are input to the 3D reconstruction DNN 512 and the 3D reconstruction DNN 512 estimates multiple 3D shape models and skeleton data with the different poses. Next, the estimated 3D shape models with the different poses containing the skeleton data are input to the pose transformation DNN 902, and the pose transformation DNN 902 estimates the pose-transformed 3D shape models 914 to 916 with the same pose containing the skeleton data.

In S332, the CPU 102 performs scale conversion on the multiple pose-transformed 3D shape models containing the skeleton data obtained in S331. As presented in FIG. 9B, the pose-transformed 3D shape model 915 has narrower facial and torso lateral widths than the pose-transformed 3D shape model 914 has, and the pose-transformed 3D shape model 916 has a wider torso lateral width and longer hands than the pose-transformed 3D shape model 914 has. In this way, even though the same object representing the same person is reconstructed and transformed into the same pose, the scales, such as height and thickness, of the pose-transformed 3D shape models may vary and the 3D shape models may differ in the global coordinate system. This is because, as explained using FIG. 7, it is difficult for the 3D reconstruction DNN to estimate the size in the depth direction in the camera coordinate system of the image capture camera with high accuracy, which results in a variation in the accuracy between the 3D shape models. Therefore, in S332, the scales of the 3D shape models are adjusted using the skeleton data corresponding to the 3D shape models, making it easier to associate corresponding regions in the multiple pose-transformed 3D shape models with each other.

For this purpose, in S332, first, as a reference scale to serve as a scale after adjustment, the most reliable skeleton vector in the pose-transformed skeleton data is determined as follows. An object IDi is set for each of the 3D shape models and the pose-transformed skeleton vector is denoted by [symbol] _{i, h}. As the reliability of each estimated skeleton vector, used is an estimated value (confidence map value) at the estimated joint position coordinates Jₕ before the pose transformation obtained by the skeleton estimation DNN. An object IDQₕ of the skeleton vector with the highest likelihood at the joint h is determined according to Formula (10).

$${Q}_{h} = arg max \frac{{P}_{i} ( {J}_{i , h} ) + {P}_{i} ( {J}_{i , parent ( h )} )}{2} \qquad Formula ( 10 )$$

Here, the joint 1 (Pelvis) is the root position in each pose-transformed 3D shape model, and J₁ is located at the same position in the skeleton data contained in all the pose-transformed 3D shape models. Therefore, in Formulae (9) and (10), h=2, . . . , H. Thus, the skeleton vector with the highest likelihood at the joint h is [symbol] _{Q}_{ₕ}_{, h}.

In S332, the scales of the other pose-transformed 3D shape models containing the skeleton data are converted to the scales matching with the most reliable skeleton vector [symbol] _{Q}_{ₕ}_{, h} determined in this manner. Let the point coordinates after scale conversion of a point

$${s}_{T}^{i} ( ∈ {S}_{T}^{i} )$$

on the pose-transformed 3D shape model

$${S}_{T}^{i}$$

of the object IDi be

$${w}_{T}^{h}$$

The point coordinates

$${s}_{T}^{{i}^{′}}$$

are expressed as Formula (11) using the degree of influence

$${s}_{T}^{{i}^{′}} ( ∈ {S}_{T}^{{i}^{′}} ) .$$

of the joint h on the point

$${s}_{T}^{i}$$

defined above in Formula (8).

$${s}_{T}^{{i}^{′}} = {\sum }_{h = 1}^{H} {w}_{T}^{h} ( {{Q}_{h} , h}_{} - {i , h}_{} ) {s}_{T}^{i} \qquad Formula ( 11 )$$

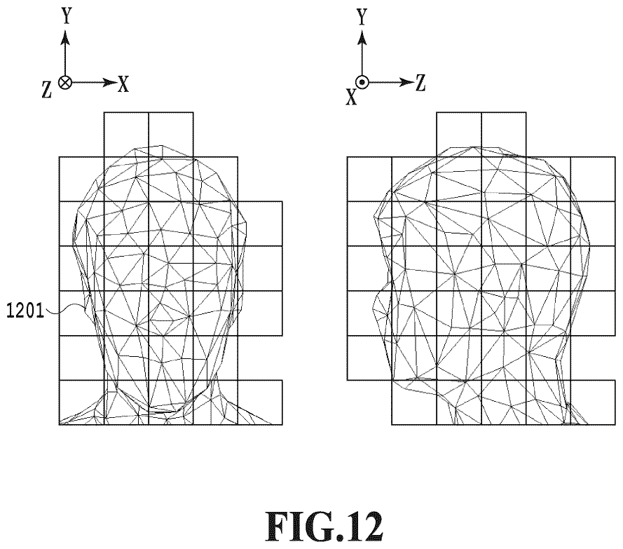

In S333, the CPU 102 divides each of the scale-converted 3D shape models into subregions. Any division granularity may be used. However, in the case where the 3D shape models are converted to the same scale by using their skeleton data, differences in thickness remain among the 3D shape models. For this reason, the region division is performed by using grids in a size that can cover the differences in thickness. Therefore, the grid size is set to be larger than the differences in thickness among the 3D shape models and the 3D spaces are divided. FIG. 12 presents an example where a 3D space in which a 3D shape model 1201 is present is divided by grids. The left side of FIG. 12 is a diagram seen from the Z axis direction, and the right side of FIG. 12 is a diagram seen from the X axis direction.

In S334, the CPU 102 calculates the likelihood (second likelihood) for each subregion. The likelihood for each subregion is calculated by using the first likelihood of the polygon calculated in S323. If the number of division grids is denoted by G, the likelihood C_{g} for each grid g is given by Formula (12), where N_{g} denotes the number of polygons present in the grid g.

$${C}_{g} = \frac{{\sum }_{M = 1}^{{N}_{g}} \frac{{A}_{M , g}}{{A}_{M}} {LH}_{M}}{{\sum }_{M = 1}^{{N}_{g}} \frac{{A}_{M , g}}{{A}_{M}}} \qquad Formula ( 12 )$$

Here, A_{M} denotes the area of a polygon M and A_{M,g} denotes the area of the polygon M inside the grid g. Naturally,

$${\sum }_{g = 1}^{G} {A}_{M , g} = {A}_{M}$$

holds.

### <3D Shape Model Creation Process by Combining Multiple 3D Shape Models (S340)>

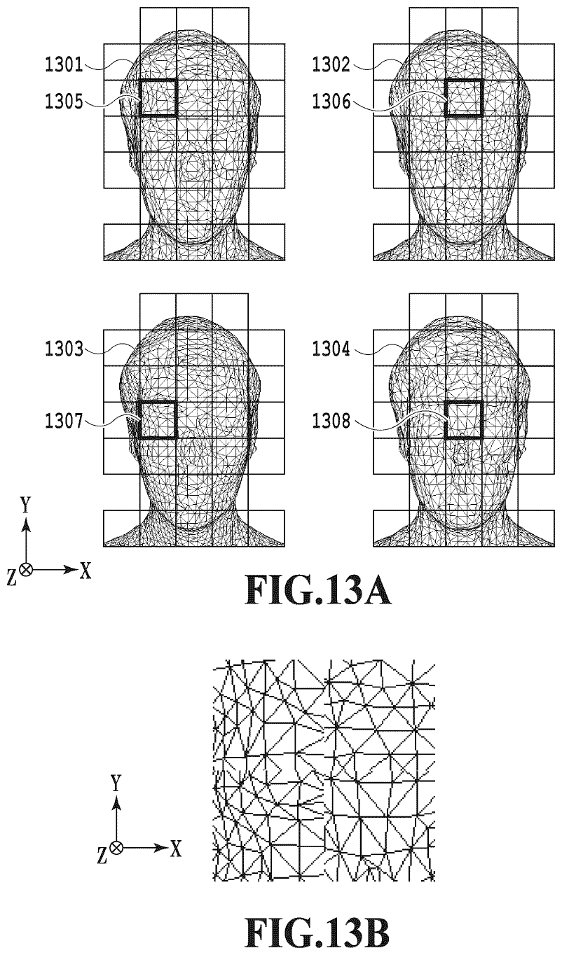

Hereinafter, the 3D shape model creation process by combining subregions with the highest likelihoods in S340 will be described. FIG. 3E presents a flowchart. For convenience of description, considered herein is a case where subregions 1305, 1306, 1307, and 1308 with high likelihoods in scale-adjusted 3D shape models 1301, 1302, 1303, and 1304 illustrated in FIG. 13A are combined.

In S341, for each grid, the CPU 102 extracts a subregion with the highest likelihood of the polygons from the multiple 3D shape models obtained in S310.

In S342, the CPU 102 converts the polygons for each grid extracted in S341 into voxels and combines them to create a 3D voxel map of a single 3D shape model. In a case where 3D shape models per grid extracted from different 3D shape models are combined, gaps between polygons are generated at the grid boundaries as presented in FIG. 13B. In the case where a 3D shape model is created by combining the polygons having the gaps at the grid boundaries, voids are created in the 3D shape model. To address this, the estimated voxel value of the voxel abutting on the polygon is stored in voxels near each polygon and voxel values are stored in the adjacent voxels in the direction of the normal of the polygon used to calculate the likelihood of the polygon. Among the voxels near the polygon, voxels located inside the object region store a voxel value of 1, and voxels located outside the object region store a voxel value of 0.

In S343, the CPU 102 converts the 3D voxel map created in S342 to the mesh format by the marching cubes method or the like.

As described above, in the present embodiment, an accurate 3D shape model can be created by combining the accurate subregions in the multiple 3D shape models that are estimated independently from multiple frames of a moving image or multiple still images obtained by capturing the same object.

### Embodiment 2

The present embodiment is a modification of Embodiment 1. A system configuration diagram in the present embodiment is the same as in Embodiment 1. In the present embodiment, based on user's preferences according to user's GUI operations, a preferred 3D shape model among multiple 3D shape models is applied to each selected subregion, so that a 3D shape model with a combination of desired subregions can be created. In Embodiment 2, the user's GUI operations are performed via the operation unit 106 and the display unit 107. A conceivable hardware on which the GUI is operated and displayed is any device that functions as the operation unit 106 and the display unit 107, such as a tablet terminal, a smartphone, or a PC.

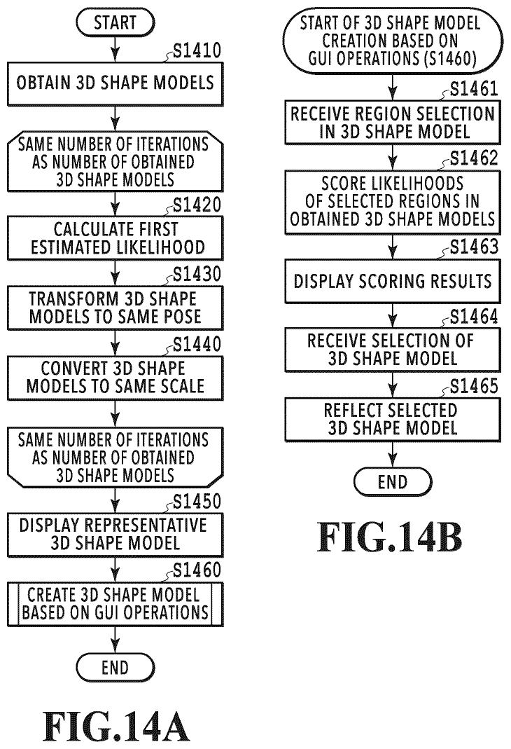

FIG. 14A presents a flowchart for explaining 3D shape model creation processing in the present embodiment. Since S1410, S1420, S1430, and S1440 are the same as S310, S320, S331, and S332 in the flowchart of Embodiment 1, their description is omitted herein.

In S1450, the CPU 102 creates a GUI for presenting a representative 3D shape model to serve as a base and causes the display unit 107 to display the GUI. The representative 3D shape model may be a model, as described in Embodiment 1, created by dividing each of 3D shape models estimated independently from different observational information into subregions based on grids in a predetermined size and combining the subregions with the highest likelihoods of the polygons in the respective grids. The representative 3D shape model is not limited to this, and may be an appropriate single 3D shape model or may be a model created from multiple frames in a moving image as disclosed in Non Patent Literature 1.

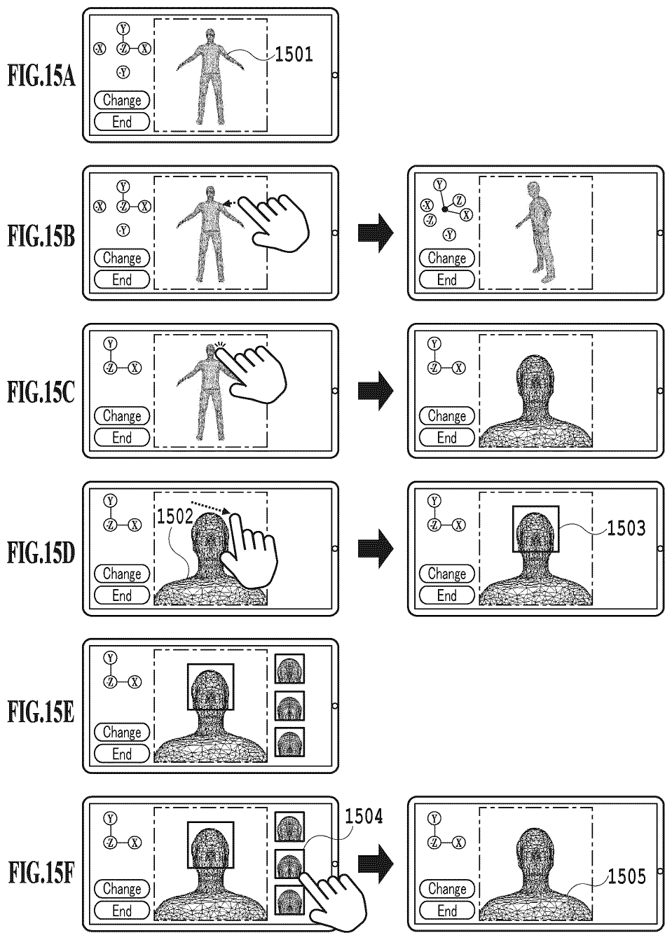

FIGS. 15A to 15F present an example of GUI screens displayed on a tablet terminal according to the present embodiment. FIG. 15A presents a representative 3D shape model 1501 displayed on a screen of the tablet terminal. In this tablet terminal, the screen functioning as the operation unit 106 and the display unit 107 can receive user's operations on the displayed representative 3D shape model. For example, as presented in FIG. 15B, in a case where the user touches the representative 3D shape model displayed on the tablet terminal and slides his/her finger in a direction in which the user desires to see, the representative 3D shape model is rotated. As a result, the representative 3D shape model presenting an appearance from the direction in which the user desires to see can be displayed.

In S1460, the CPU 102 creates a 3D shape model with high accuracy based on user's input GUI operations received by the operation unit 106. FIG. 14B presents a flowchart for explaining the process of creating the 3D shape model in S1460.

In S1461, the CPU 102 receives a selection of a region in the 3D shape model based on a user's input GUI operation received by the operation unit 106. As presented in FIG. 15C, in response to user's tapping on a portion that the user desires to correct, the portion can be displayed in an enlarged manner. Then, as presented in FIG. 15D, in response to a user's selection of a region that the user desires to correct by dragging on a 3D shape model 1502 displayed in the enlarged manner, a grid 1503 is generated and polygons in the generated grid are set as the selected region.

In S1462, according to Formula (12), the CPU 102 calculates and scores the likelihood of the subregion representing the selected region for each of the 3D shape models obtained in S1410. The score may be the likelihood itself or be a value obtained by processing the likelihood.

In S1463, the CPU 102 generates a GUI for displaying the scoring results of the calculated likelihoods, and causes the display unit 107 to display the GUI. Here, as presented in FIG. 15E, three 3D shape models with the highest scores are displayed as candidates. If the user does not like any of these candidate 3D shape models, the user presses down a “Change” button to switch to other three 3D shape models with the next highest scores.

In S1464, the CPU 102 receives a user's selection of one 3D shape model from the candidate 3D shape models based on a user's input GUI operation received by the operation unit 106.

In S1465, the CPU 102 replaces the selected region in the representative 3D shape model with the selected region in the 3D shape model selected in S1464, generates a GUI for displaying the 3D shape model reflecting the user's selection, and causes the display unit 107 to display the GUI. The method of combining the 3D shape models in this step is the same as in S341 and S342 in Embodiment 1. As presented in FIG. 15F, in a case where the user selects a 3D shape model 1504, a 3D shape model 1505 in which the selected region is replaced with the 3D shape model 1504 is created. In a case where an “End” button is pressed down, the 3D shape model creation processing is ended.

With the GUIs provided as described above, the user is allowed to check and select subregions with the high accuracy in the 3D shape models and combine them, making it easier to create the 3D shape model desired by the user. In addition, the granularity of a subregion to be corrected can be also easily set as the user desires.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to create a 3D shape model with a higher level of detail based on multiple different 3D shape models.

This application claims the benefit of Japanese Patent Application No. 2024-111842, filed Jul. 11, 2024, which is hereby incorporated by reference herein in its entirety.

1. An information processing apparatus, comprising:
one or more hardware processors; and
one or more memories storing one or more programs configured to be executed by the one or more hardware processors, the one or more programs including instructions for:
obtaining a plurality of different three-dimensional shape models for a single object;
calculating a likelihood of each of subregions in each of the plurality of three-dimensional shape models; and
creating a single three-dimensional shape model for the single object by combining subregions in the plurality of three-dimensional shape models based on the likelihoods.

2. The information processing apparatus according to claim 1, wherein the plurality of three-dimensional shape models are created by a model trained to create a three-dimensional shape model from a captured image obtained by capturing the single object.

3. The information processing apparatus according to claim 1, wherein the one or more programs further include instructions for:
calculating a likelihood of each polygon in the plurality of three-dimensional shape models; and
calculating the likelihood of each of the subregions based on the likelihoods of the polygons.

4. The information processing apparatus according to claim 3, wherein the one or more programs further include instructions for:
obtaining the plurality of three-dimensional shape models as voxel maps; and
calculating the likelihood of the polygon based on a voxel value in the voxel map of a voxel abutting on the polygon.

5. The information processing apparatus according to claim 4, wherein the one or more programs further include instructions for calculating the likelihood of the polygon from a difference between the voxel values of adjacent voxels in a normal direction of the polygon.

6. The information processing apparatus according to claim 4, wherein the one or more programs further include instructions for creating the single three-dimensional shape model by combining the voxel maps for the subregions.

7. The information processing apparatus according to claim 1, wherein the one or more programs further include instructions for:
obtaining a skeleton corresponding to each of the plurality of three-dimensional shape models; and
transforming the poses of the plurality of three-dimensional shape models into the same pose based on the skeletons before combining the subregions.

8. The information processing apparatus according to claim 7, wherein the one or more programs further include instructions for converting the scales of the plurality of three-dimensional shape models to the same size based on the skeletons before combining the subregions.

9. The information processing apparatus according to claim 1, wherein the one or more programs further include instructions for:
displaying the three-dimensional shape models;
receiving a user's input; and
using a subregion selected based on the user's input with the selected subregion in one three-dimensional shape model selected based on the user's input from the plurality of three-dimensional shape models.

10. The information processing apparatus according to claim 9, wherein the one or more programs further include instructions for:
receiving a selection of a subregion in the three-dimensional shape models; and
changing the subregion selected by a user to the selected subregion in another three-dimensional shape model.

11. The information processing apparatus according to claim 10, wherein the one or more programs further include instructions for:
referring to the likelihood of the selected subregion;
selecting three-dimensional shape models in the selected subregion from the plurality of three-dimensional shape models based on the likelihoods of the subregion and displaying the selected three-dimensional shape models; and
receiving a user's selection of the three-dimensional shape model in the selected subregion from the displayed three-dimensional shape models.

12. An information processing method comprising the steps of:
obtaining a plurality of different three-dimensional shape models for a single object;
calculating a likelihood of each of subregions in each of the plurality of three-dimensional shape models; and
creating a single three-dimensional shape model for the single object by combining subregions in the plurality of three-dimensional shape models based on the likelihoods.

13. A non-transitory computer readable storage medium storing a program for causing a computer to perform a control method of an information processing apparatus, the control method comprising the steps of:
obtaining a plurality of different three-dimensional shape models for a single object;
calculating a likelihood of each of subregions in each of the plurality of three-dimensional shape models; and
creating a single three-dimensional shape model for the single object by combining subregions in the plurality of three-dimensional shape models based on the likelihoods.
